(19) United States
(12) Patent Application Publication
(10) Pub. No.: US 2024/0204252 A1
(43) Pub. Date: Jun. 20, 2024

(54) ADDITIVE FOR LITHIUM-ION BATTERY ELECTROLYTE, ELECTROLYTE, AND LITHIUM-ION SECONDARY BATTERY

(71) Applicant: MURATA MANUFACTURING CO., LTD., Kyoto (JP)

(72) Inventors: Cheng Zhu, Shanghai (CN); Hao ZHANG, Shanghai (CN); Yingtao CHEN, Shanghai (CN)

(21) Appl. No.: 18/439,278

(22) Filed: Feb. 12, 2024

Related U.S. Application Data
(63) Continuation of application No. PCT/CN2022/109429, filed on Aug. 1, 2022.

(30) Foreign Application Priority Data
Sep. 30, 2021 (CN) 202111166334.2

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0028; H01M 2300/0051

(57) ABSTRACT

Provided are an additive for a lithium-ion battery electrolyte, an electrolyte comprising same, and a lithium-ion secondary battery. In particular, provided is an additive used for a lithium-ion battery electrolyte. The additive comprises a first additive having the structure of formula (1), each individual Ar being an aromatic group substituted with the following substituent groups: a trifluoromethyl group, a trifluoromethyl alkyl group, a methoxy group, a trifluoromethoxy group, or a trifluoromethyl alkoxy group, at least one of the substituent groups being a trifluoromethyl group, a trifluoromethyl alkyl group, a trifluoromethoxy group, or a trifluoromethyl alkoxy group; and optionally, a second additive having the structure of formula (2), R representing a divalent saturated or unsaturated hydrocarbon group. Also disclosed are an electrolyte for a lithium-ion battery containing the additive, and a lithium-ion battery containing the electrolyte.

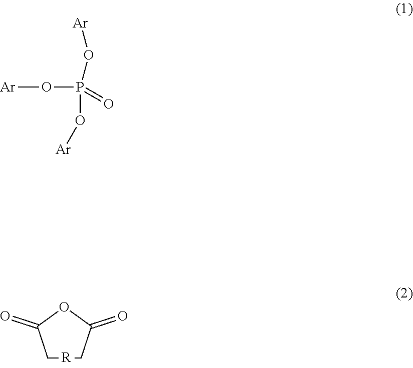

### CROSS REFERENCE TO RELATED APPLICATIONS

The present application is a continuation of PCT patent application no. PCT/CN2022/109429, filed on Aug. 1, 2022, which claims priority to Chinese patent application no. 202111166334.2, filed on Sep. 30, 2021, the entire contents of which are incorporated herein by reference.

### BACKGROUND

The present application relates to the field of lithium-ion secondary batteries, and in particular to an additive for a lithium-ion battery electrolyte, an electrolyte containing the same, and a lithium-ion secondary battery.

In recent years, with the continuous development of electronic technology, the requirements for battery devices for supporting energy supply of electronic equipment are also continuously increased. Nowadays, there is a need for batteries that can store more electric energy and output a high power. Traditional lead-acid batteries and nickel-metal hydride batteries can no longer meet the requirements of new electronic products. Therefore, lithium batteries have attracted extensive attention. In the development process of lithium batteries, the capacity and properties thereof have been effectively improved.

In lithium-ion batteries, ternary positive electrode materials have become a hot spot in research and development because of their high specific capacity for use in electric tools and electric vehicles. Therefore, the performance of ternary materials in terms of safety, especially the comprehensive performance under a high voltage and a high temperature is very important. At present, the common problems of ternary materials include poor cycle performance at a high temperature, more side reactions on the electrode interface, and phase transition at a high voltage leading to oxygen evolution in the lattice, and therefore battery performance becomes degraded. An electrolyte, as a carrier for lithium-ion conduction, is mainly composed of an organic solvent, a lithium salt and a functional additive. The traditional electrolyte system is mainly improved for the negative electrode, but not enough for the positive electrode. Especially under a high voltage, the stability of a solvent and an additive is poor, resulting in rapid deterioration of battery performance. Further, under high temperature conditions, especially under the instantaneous high-rate discharge of electric vehicles the electrolyte can be further deteriorated. In summary, the oxidation resistance of electrolytes and electrolyte additives for positive electrode materials is an urgent problem to be solved.

### SUMMARY

The present application, in an embodiment, relates to providing an additive for a lithium-ion battery electrolyte, an electrolyte and a lithium-ion secondary battery containing same, to solve the problem of poor oxidation resistance and cycle performance of lithium-ion batteries in the prior art under a high temperature and a high pressure.

According to an embodiment, provided is an additive for a lithium-ion battery electrolyte, wherein the additive comprises a first additive having a structure of following formula (1):

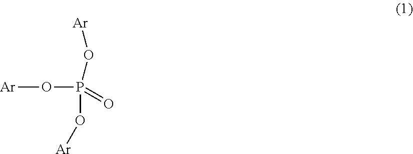

wherein each Ar is independently an aromatic group substituted with at least one substituents as follows: a trifluoromethyl group, a trifluoromethyl alkyl group, a methoxy group, a trifluoromethoxy group, or a trifluoromethyl alkoxy group, wherein at least one of the at least one substituents is a trifluoromethyl group, a trifluoromethyl alkyl group, a trifluoromethoxy group, or a trifluoromethyl alkoxy group, and

optionally a second additive having a structure of following formula (2):

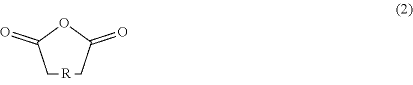

wherein R represents a divalent saturated or unsaturated hydrocarbon group.

Further, in the additives above, in formula (I), the aromatic group is a phenyl group, a naphthyl group, or an anthracyl group.

Further, among the additives above, the first additive is any one selected from:

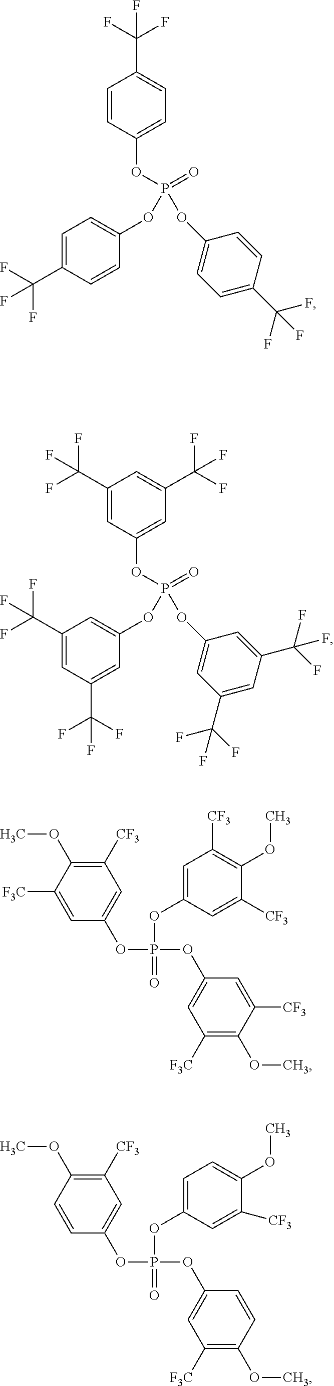 [SMILES: O=P(Oc1ccc(C(F)(F)F)cc1)(Oc1ccc(C(F)(F)F)cc1)Oc1ccc(C(F)(F)F)cc1 ; O=P(Oc1cc(C(F)(F)F)cc(C(F)(F)F)c1)(Oc1cc(C(F)(F)F)cc(C(F)(F)F)c1)Oc1cc(C(F)(F)F)cc(C(F)(F)F)c1 ; COc1c(C(F)(F)F)cc(OP(=O)(Oc2cc(C(F)(F)F)c(OC)c(C(F)(F)F)c2)Oc2cc(C(F)(F)F)c(OC)c(C(F)(F)F)c2)cc1C(F)(F)F ; COc1ccc(OP(=O)(Oc2ccc(OC)c(C(F)(F)F)c2)Oc2ccc(OC)c(C(F)(F)F)c2)cc1C(F)(F)F]

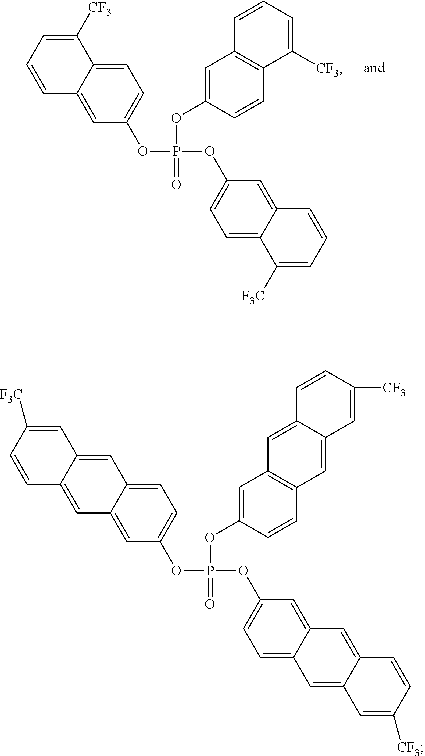 [SMILES: O=P(Oc1ccc2c(C(F)(F)F)cccc2c1)(Oc1ccc2c(C(F)(F)F)cccc2c1)Oc1ccc2c(C(F)(F)F)cccc2c1 ; "and" ; O=P(Oc1ccc2cc3cc(C(F)(F)F)ccc3cc2c1)(Oc1ccc2cc3cc(C(F)(F)F)ccc3cc2c1)Oc1ccc2cc3cc(C(F)(F)F)ccc3cc2c1]

and the second additive is any one selected from:

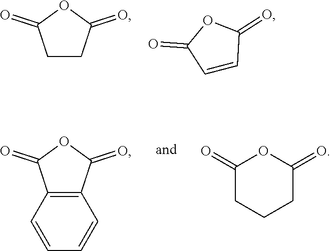

According to another embodiment, provided is an electrolyte for a lithium-ion battery, wherein the electrolyte comprises an additive according to the aspects above, an organic solvent, and a lithium salt.

Further, in the electrolyte, based on 100 parts by weight of the organic solvent and the lithium salt, the amount of the first additive is in the range of 0.5 parts by weight to 4 parts by weight according to an embodiment.

Further, in the electrolyte, based on 100 parts by weight of the organic solvent and the lithium salt, the amount of the first additive is in the range of 0.5 parts by weight to 2 parts by weight according to an embodiment.

Further, in the electrolyte, when the second additive exists, based on 100 parts by weight of the organic solvent and lithium salt, the amount of the second additive is in the range of 0.5 parts by weight to 2 parts by weight according to an embodiment.

Further, in the electrolyte, the organic solvent comprises a cyclic carbonate, a linear carbonate, or any combination thereof according to an embodiment.

Further, in the electrolyte, the lithium salt is selected from the group consisting of LiCl, LiBr, LiPF₆, LiBF₄, LiASF₆, LiClO₄, LiB(C₆H₅)₄, LiCH₃SO₃, LiCF₃SO₃, LiN(SO₂CF₃)₂, LiC(SO₂CF₃)₃, LiAlCl₄, Li₂SiF₆, or combinations thereof according to an embodiment.

According to another embodiment, provided is a lithium-ion secondary battery, comprising: a positive electrode plate, a negative electrode plate, a separator, and the electrolyte according to the above-mentioned aspects of the invention.

The additive for a lithium-ion battery electrolyte, the electrolyte containing the same, and the lithium-ion secondary battery achieve the effects of improving the electrochemical performance, especially the oxidation resistance and cycle performance under a high temperature and a high pressure of a lithium-ion battery according to an embodiment.

### DETAILED DESCRIPTION

The present application relates to providing an additive for a lithium-ion battery electrolyte, an electrolyte and a lithium-ion secondary battery containing same.

It should be noted that, to the extent applicable, various embodiments in the present application and features in the various embodiments can be combined with each other. The present application will be described in further detail below including in conjunction with the examples.

In electrolytes for lithium-ion batteries, phosphorus-based compounds have received extensive attention as flame-retardant additives to improve safety, especially phosphate compounds are currently the hotspot of development. However, phosphate compounds with simple structures can form thick SEI film on the electrodes after decomposition, which will increase the internal resistance of the battery and deteriorate the cycle performance. Therefore, the introduction of a fluorinated functional group substituent is often used to improve the oxidation resistance, solubility and wettability of additives.

It is generally believed that the SEI film formed by the decomposition of a phosphate introduced with a substituent of a linear structure is relatively fluffy, which is not conducive to the stability of the interface, and the SEI film is prone to rupture during cycling, and its excessive repeated growth forms an overly thick SEI film. On the other hand, a phosphate having a substituent of a branched chain structure can be decomposed to form a denser and more stable SEI film. For example, in tris(hexafluoroisopropyl)phosphate, trifluoromethyl group is introduced as a branched chain structure, and the electron-withdrawing effect of the trifluoromethyl group will induce the decomposition of the phosphate (i.e. hydrolysis of the phosphate), thereby forming an SEI film to protect the electrodes. However, according to experimental analysis, tris(hexafluoroisopropyl)phosphate will produce hexafluoroisopropanol CF₃CH(OH)CF₃ during the decomposition process, which is a fluoroalcohol compound produced by the hydrolysis of the fluorophosphate. Such fluoroalcohol compound contains active hydrogen atoms in its molecule, and will generate compounds such as lithium carboxylate or lithium alkoxide during the first charging and discharging process of a battery. These compounds have certain solubility in an organic solvent, so they will cause the instability of the SEI film, reduce the conductivity of lithium ions, and thus reduce the cycle efficiency of a battery, and their reaction with metal lithium will also increase the irreversible capacity of the battery. Such fluoroalcohol compound therefore leads to a decrease in cycle efficiency and cycle stability. Therefore, it is necessary to eliminate or suppress the generation of the fluoroalcohol compound.

The present application, in an embodiment, relates to providing an additive for a lithium-ion battery electrolyte in view of the deficiencies in the prior art, which can inhibit the generation of a fluoroalcohol compound during the decomposition of the above-mentioned fluorophosphate additive, and effectively remove the generated fluoroalcohol compound.

According to an embodiment of the present application, provided is an additive for a lithium-ion battery electrolyte, wherein the additive comprises a first additive having a structure of the following formula (1)

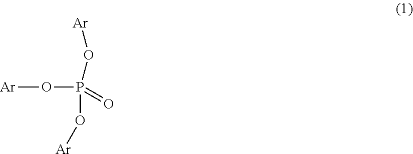

wherein each Ar is independently an aromatic group substituted with at least one substituents as follows: a trifluoromethyl group, a trifluoromethyl alkyl group, a methoxy group, a trifluoromethoxy group, or a trifluoromethyl alkoxy group, wherein at least one of the at least one substituent is a trifluoromethyl group, a trifluoromethyl alkyl group, a trifluoromethoxy group, or a trifluoromethyl alkoxy group, and

optionally a second additive having a structure of following formula (2):

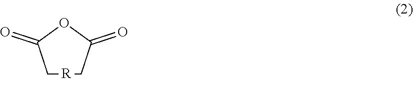

wherein R represents a divalent saturated or unsaturated hydrocarbon group.

In an embodiment of the present application, the first additive is any one selected from:

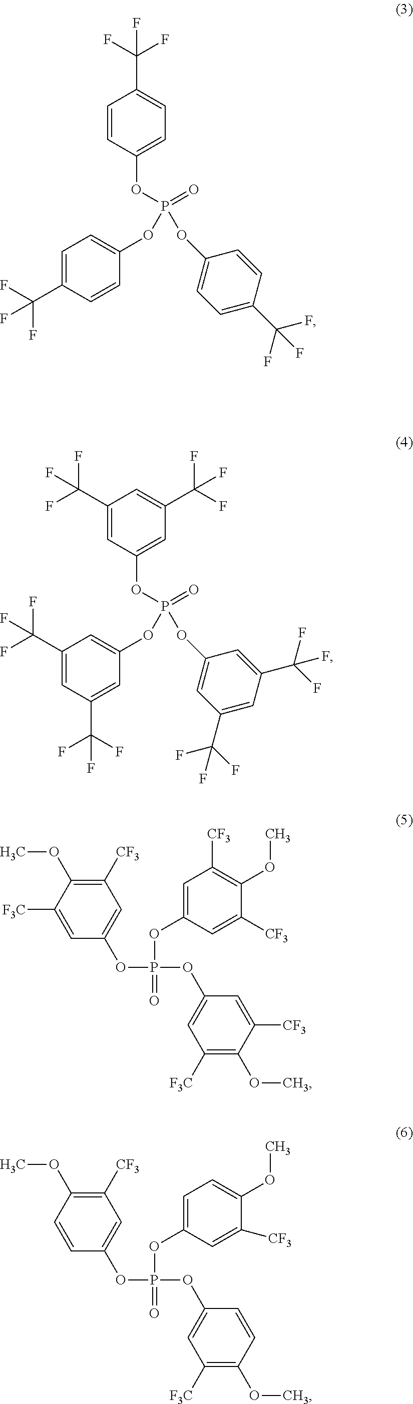 [SMILES: O=P(Oc1ccc(C(F)(F)F)cc1)(Oc1ccc(C(F)(F)F)cc1)Oc1ccc(C(F)(F)F)cc1 ; O=P(Oc1cc(C(F)(F)F)cc(C(F)(F)F)c1)(Oc1cc(C(F)(F)F)cc(C(F)(F)F)c1)Oc1cc(C(F)(F)F)cc(C(F)(F)F)c1 ; COc1c(C(F)(F)F)cc(OP(=O)(Oc2cc(C(F)(F)F)c(OC)c(C(F)(F)F)c2)Oc2cc(C(F)(F)F)c(OC)c(C(F)(F)F)c2)cc1C(F)(F)F ; COc1ccc(OP(=O)(Oc2ccc(OC)c(C(F)(F)F)c2)Oc2ccc(OC)c(C(F)(F)F)c2)cc1C(F)(F)F]

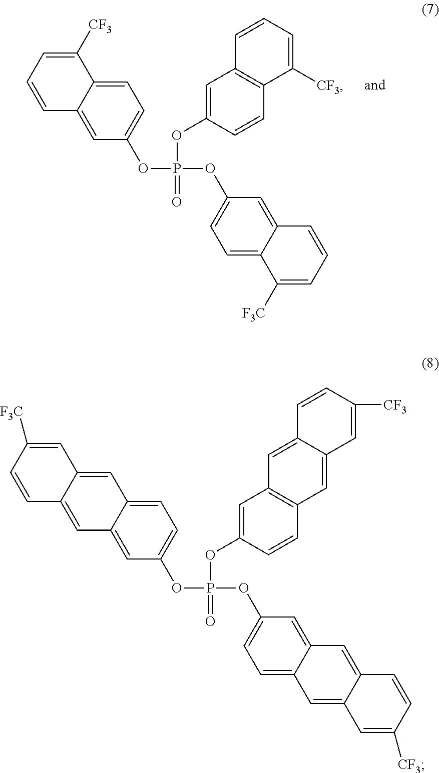 [SMILES: O=P(Oc1ccc2c(C(F)(F)F)cccc2c1)(Oc1ccc2c(C(F)(F)F)cccc2c1)Oc1ccc2c(C(F)(F)F)cccc2c1 ; "and" ; O=P(Oc1ccc2cc3cc(C(F)(F)F)ccc3cc2c1)(Oc1ccc2cc3cc(C(F)(F)F)ccc3cc2c1)Oc1ccc2cc3cc(C(F)(F)F)ccc3cc2c1]

and optionally, the second additive is any one selected from:

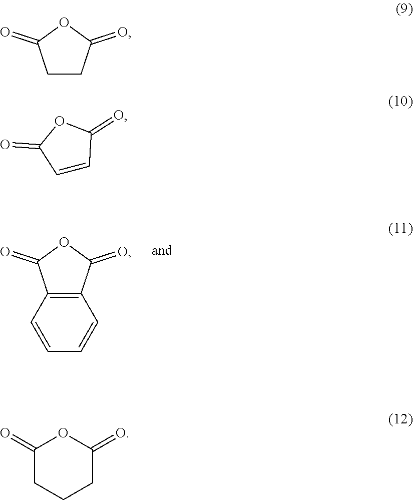 [SMILES: O=C1CCC(=O)O1 ; O=C1C=CC(=O)O1 ; O=C1OC(=O)c2ccccc21 ; O=C1CCCC(=O)O1]

The inventors have found through research that the fluorine-containing phosphate additive of formula (1) according to the present technology can be decomposed on the surface of the electrode to form a stable SEI film, thereby inhibiting the oxidative decomposition of the electrolyte at the positive electrode and inhibiting the dissolution of metal ions. Moreover, the stable phosphate can inhibit the evolution of oxygen, thereby inhibiting the gas production and the volume growth of the battery, stabilizing the positive electrode and improving the electrochemical performance of the battery at a high temperature. On the other hand, the introduction of a fluorine-containing group, especially a trifluoromethyl group, can improve the solubility and wettability of the additive, and further enhance the oxidation resistance of the phosphate, thereby improving the high-temperature and low-temperature characteristics of the battery. In addition, the ionic conductivity can be improved to improve the rate capability of the battery.

The reaction mechanism wherein the additive of the present invention (taking the compound of formula (3) as an example) is attacked by the nucleophile (Nu−) during the battery cycle and decomposes on the electrode surface to form an SEI film is as follows:

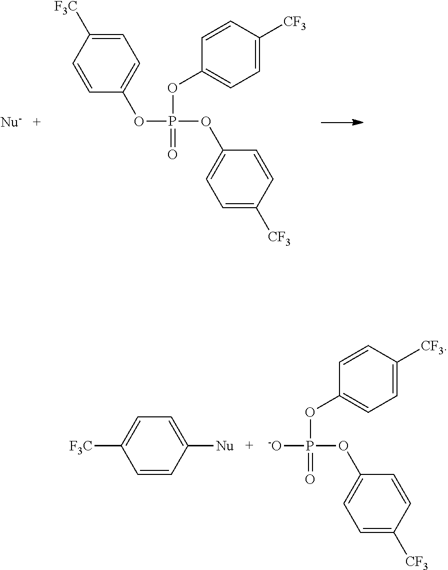

In addition, as for the problem that a fluorophosphate additive decomposes to produce a fluoroalcohol compound and deteriorates battery performance, the inventors have found that the hydrolysis of the phosphate is the main cause of the problem, and the strong electron-withdrawing effect of the fluorine-containing group in the fluorophosphate additive will activate the decomposition reaction.

Therefore, an aromatic ring side chain, such as a phenyl group, a naphthyl group or an anthracyl group, is introduced into the first additive of formula (1) according to an embodiment. The steric hindrance effect of the aromatic group can effectively weaken the strong electron-withdrawing effect of the trifluoromethyl group, and inhibits the hydrolysis reaction of the phosphate, thereby reducing the generation of a fluoroalcohol compound and protecting the electrode from the compound, so as to improve the cycle efficiency and cycle stability of the battery.

In addition, the introduction of the aromatic group into the first additive of formula (1) of the invention can weaken the addition ability of the reaction site of the first additive, thereby preventing the problem that the SEI film is too thick due to excessive polymerization of the first additive and improving the rate capability and cycle characteristics of the battery.

In an embodiment, adding the second cyclic dianhydride additive of formula (2) can effectively remove the fluoroalcohol compound produced by the decomposition of the first additive of formula (1) through esterification, and further eliminate its degrading effect on the battery performance.

The reaction of the second cyclic dianhydride additive (taking the compound of formula (9) as an example) with the fluoroalcohol compound (taking hexafluoroisopropanol as an example) is as follows:

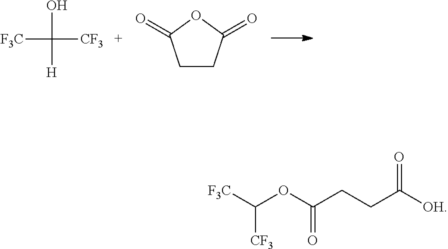

It should be noted that a conventional esterification reaction requires alkali catalysis, but in an electrolyte, an alkaline environment cannot be guaranteed due to the decomposition of a lithium salt to generate HF during the battery cycle.

In the present technology, the weak alkalinity of LiPF₆ in the lithium battery electrolyte is utilized, and the dianhydride additive with high reactivity is used to complete the esterification reaction and effectively remove the fluoroalcohol compound, thereby improving the cycle characteristic of the battery. Moreover, the decomposition product of the second additive of formula (2) of the present technology and the decomposition product of the first additive of formula (1) can be esterfied to form an ester compound containing an aryl group, which can improve the wettability of the electrodes and separator and improve the compatibility with the cyclic carbonate solvent in the electrolyte, thereby reducing the internal resistance of the battery and improving cycle characteristics.

In addition, the second dianhydride additive of formula (2) of the present technology has high water absorption, which is beneficial for removing and effectively controlling the moisture in the electrolyte system. Therefore, it can inhibit the decomposition of LiPF₆ in the electrolyte, thereby inhibiting battery performance deterioration due to HF generation, and ensuring proceeding of the esterification reaction. Further, the hydrolysis reaction of the fluorophosphate is inhibited, and the production of the fluoroalcohol compound is further inhibited.

It can be determined from the description above that by adding the second additive of formula (2) of the present technology, a synergistic effect can be produced with the first additive of formula (1), thereby improving the performance of the battery more effectively.

In a further embodiment, there is no carbon-carbon double bond in the compound of formula (9) and formula (12), so that the compounds have higher reactivity, and are easier to undergo an esterification reaction to remove the fluoroalcohol compound.

According to another embodiment, provided is an electrolyte for a lithium-ion battery, comprising the additives according to the various aspects of the invention, an organic solvent, and a lithium salt. The amount of the first additive is in the range of 0.5 parts by weight to 4 parts by weight based on 100 parts by weight of the organic solvent and the lithium salt. Preferably, the amount of the first additive is in the range of 0.5 parts by weight to 2 parts by weight based on 100 parts by weight of the organic solvent and the lithium salt. As described in detail in the following examples, when the amount of the first additive is lower than this range, the cycle retention rate and volume growth rate of the battery are adversely affected; and when the amount of the first additive is higher than this range, the cycle retention rate and volume growth rate of the battery are adversely affected, and at the same time the costs of the electrolyte are increased.

In addition, in a further embodiment, there is a second additive in the electrolyte for a lithium-ion battery, the amount of the second additive is in the range of 0.5 parts by weight to 2 parts by weight based on 100 parts by weight of the organic solvent and lithium salt. As described in detail in the following examples, when the amount of the second additive is lower than this range, the cycle retention rate and volume growth rate of the battery are adversely affected; and when the amount of the second additive is higher than this range, the costs of the electrolyte are unnecessarily increased.

According to a further embodiment of the present application, the organic solvent used in the electrolyte of the lithium-ion battery comprises a cyclic carbonate, a linear carbonate, or any combination thereof.

In an embodiment, the organic solvent is selected from propylene carbonate, butylene carbonate, fluoroethylene carbonate, ethylene carbonate, diethyl carbonate, dipropyl carbonate, ethyl methyl carbonate, dimethyl carbonate, or combinations thereof.

As described above, by using the first additive of formula (1) and the second additive of formula (2) of the present technology, the compatibility with the cyclic carbonate solvent in the electrolyte can be improved, thereby reducing the internal resistance of the battery and improving cycle characteristics. In addition, by adding the additives of the invention to an electrolyte comprising a cyclic carbonate solvent, a linear carbonate solvent and a lithium salt, it is possible to overcome the problem in the prior art that a fluorophosphate additive decomposes to produce a fluoroalcohol compound, thereby improving the cycle efficiency and cycle stability of the battery.

According to an embodiment, the lithium salt in the electrolyte for a lithium-ion battery of the invention is selected from the group consisting of LiCl, LiBr, LiPF₆, LiBF₄, LiASF₆, LiClO₄, LiB(C₆H₅)₄, LiCH₃SO₃, LiCF₃SO₃, LiN(SO₂CF₃)₂, LiC(SO₂CF₃)₃, LiAlCl₄, Li₂SiF₆, or combinations thereof. As described above, the additive of the invention utilizes the weak alkalinity of LiPF₆ in the lithium battery electrolyte for esterification, effectively removes the fluoroalcohol compound, and inhibits the decomposition of LiPF₆ in the electrolyte, thereby inhibiting the deterioration of the battery performance caused by HF generation and improving the cycle characteristics of the battery.

According to another embodiment, provided is a lithium-ion secondary battery, comprising: a positive electrode plate, a negative electrode plate, a separator, and the electrolyte.

In an embodiment, the lithium-ion secondary battery of the invention is prepared as further detailed below.

Preparation of a positive electrode plate: A positive electrode active material, a conductive agent, a binder, and a dispersant are mixed to obtain a positive electrode mixture, and the positive electrode mixture is dispersed in a solvent to obtain a positive electrode mixture slurry. Then, the positive electrode mixture slurry is coated onto a positive electrode current collector such as aluminum foil, dried, and pressed to form a positive electrode plate.

Preparation of a negative electrode plate: A negative electrode active material, a conductive agent, a binder, and water are stirred to prepare a negative electrode slurry. The negative electrode slurry is then coated onto a negative electrode current collector such as copper foil, dried, and pressed to form a negative electrode plate.

Preparation of an electrolyte: The above-mentioned organic solvent, lithium salt, and additives are mixed to prepare an electrolyte.

Assembly of battery: The positive electrode plate prepared in the described step as a positive electrode, the negative electrode plate prepared in the described step as a negative electrode, and the electrolyte, a separator, and a battery housing are assembled into a battery.

The present application, in an embodiment, will be described in further detail below in conjunction with examples, where the present application is not limited thereto.

### Comparative Example

A lithium-ion battery used in the Comparative example is prepared by the following procedure.

Preparation of a positive electrode plate: A positive electrode active material nickel cobalt lithium aluminate NCA (specifically LiNi_{0.8}Co_{0.15}Al_{0.05}O₂) (95.50 g), conductive carbon black (2.50 g), a binder polyvinylidene fluoride (1.90 g), and a dispersant polyvinylpyrrolidone (0.10 g) were mixed to obtain a positive electrode mixture, and the positive electrode mixture was dispersed in N-methylpyrrolidone to obtain a positive electrode mixture slurry. The positive electrode mixture slurry was then coated onto a positive electrode collector made of aluminum foil, dried, and pressed to form a positive electrode plate.

Preparation of a negative electrode plate: A mixture (95.85 g) of a negative electrode active material silicon oxide and graphite powder (wherein the weight ratio of silicon oxide to graphite is 9: 1), conductive carbon black (1.00 g), binders carboxymethylcellulose and styrene-butadiene latex (3.15 g), and an appropriate amount of water were stirred to prepare a negative electrode mixture slurry. Then, the negative electrode mixture slurry was uniformly coated onto the negative electrode current collector made of copper foil, dried, and pressed to form a negative electrode plate.

Preparation of an electrolyte: Ethylene carbonate (20.00 g), dimethyl carbonate (62.00 g), and lithium hexafluorophosphate (18.00 g) were mixed to prepare a basic electrolyte.

Battery assembly: a CR2016 button battery was assembled in a dry laboratory. The positive electrode plate prepared by the steps above as the positive electrode, the negative electrode plate as the negative electrode, and the electrolyte, a separator and a battery housing of a button battery were assembled. After the battery was assembled, it was left to age for 12 hours to obtain an NCA button battery.

### Examples 1-14

Lithium-ion batteries of Examples 1-14 were prepared using the same procedure as the Comparative example above. The difference is that in Examples 1-14, in the preparation step of the electrolyte, ethylene carbonate (20.00 g), dimethyl carbonate (62.00 g), and lithium hexafluorophosphate (18.00 g) were mixed to prepare a basic electrolyte, and additive A1 (i.e. the compound of formula (3) of the invention), additive A2 (i.e. the compound of formula (4) of the invention), and/or additive B (i.e. the compound of formula (9) of the invention) were added to the 100.00 g of prepared basic electrolyte. The amount of various additives added to 100.00 g of the basic electrolyte is shown in Table 1.

TABLE 1
Additives and addition amounts thereof in 100.00
g of the basic electrolyte in the examples

| | Additive A1 | Additive A2 | Additive B |
|---|---|---|---|
| | (g) | (g) | (g) |
| Comparative | 0 | 0 | 0 |
| example | | | |
| Example 1 | 0.50 | 0 | 0.50 |
| Example 2 | 1.00 | 0 | 1.00 |
| Example 3 | 2.00 | 0 | 1.00 |
| Example 4 | 4.00 | 0 | 2.00 |
| Example 5 | 5.00 | 0 | 2.00 |
| Example 6 | 0.10 | 0 | 0.10 |
| Example 7 | 0 | 0.50 | 0.50 |
| Example 8 | 0 | 1.00 | 1.00 |
| Example 9 | 0 | 2.00 | 1.00 |
| Example 10 | 0 | 4.00 | 2.00 |
| Example 11 | 0 | 5.00 | 2.00 |
| Example 12 | 0 | 0.10 | 0.10 |
| Example 13 | 1.00 | 0 | 0 |
| Example 14 | 0 | 1.00 | 0 |

### Battery Performance Test

For the batteries prepared in the Comparative example and Examples 1-14, charging and discharging tests and impedance tests were performed at room temperature and at 2.5-4.25 V.

First, 0.1 C cycle test was performed at 25° C. for 1 cycle, and then 5 C cycle test was performed at 60° C. for 100 cycles. The capacity of the battery before and after the cycle test at 60° C. was measured respectively to determine the cycle retention rate of the battery at 60° C., and the volume of the battery before and after the cycle test was measured respectively to determine the volume growth rate of the battery. In addition, 10 C cycle test was performed at 25° C. The capacity of the battery before and after the cycle test at 25° C. was measured respectively to determine the cycle retention rate of the battery at 25° C.

Volume growth rate [%]=((battery volume after the 100th cycle−battery volume before the 1st cycle)/battery volume before the 1st cycle)×100

Cycle retention rate [%]=(discharge capacity of the 100th cycle/discharge capacity of the 1st cycle)×100

For the batteries prepared in the Comparative example and Examples 1-14, the results obtained in the tests above are shown in Table 2.

TABLE 2
The electrical performance test results of examples

| | 5 C cycle | 10 C cycle | Volume |
|---|---|---|---|
| | retention rate | retention rate | growth rate of |
| Test number | at 60° C. (%) | at 25° C. (%) | the battery (%) |
| Comparative | 70.34 | 48.14 | 25.65 |
| example | | | |
| Example 1 | 72.51 | 51.60 | 24.01 |
| Example 2 | 75.36 | 57.13 | 22.48 |
| Example 3 | 71.94 | 50.69 | 21.73 |
| Example 4 | 70.97 | 49.83 | 23.81 |
| Example 5 | 61.40 | 38.45 | 19.16 |
| Example 6 | 68.72 | 50.17 | 26.63 |
| Example 7 | 73.11 | 52.78 | 24.59 |
| Example 8 | 74.87 | 56.43 | 22.87 |
| Example 9 | 72.31 | 51.64 | 21.08 |
| Example 10 | 71.31 | 49.52 | 23.11 |
| Example 11 | 60.25 | 37.42 | 20.72 |
| Example 12 | 69.43 | 47.86 | 26.37 |
| Example 13 | 71.47 | 50.21 | 22.64 |
| Example 14 | 71.55 | 51.14 | 23.14 |

In the table 2 above, by respectively comparing the results of Example 13 (only using the first additive A1 of formula (3)) and Example 14 (only using the first additive A2 of formula (4)) and the Comparative example, it can be determined that, compared with the lithium-ion battery made using the electrolyte without the additive of the invention (Comparative example), the lithium-ion batteries made using the electrolyte containing the first additive of the invention (Example 13 and Example 14) show improvements in terms of 5 C cycle retention rate at 60° C., 10 C cycle retention rate at 25° C., and cell volume growth rate, respectively.

In addition, by respectively comparing the results of Example 2 (using the first additive A1 of formula (3) and the second additive B of formula (9)) and Example 13 (only using the first additive A1 of formula (3)), as well as Example 8 (using the first additive A1 of formula (4) and the second additive B of formula (9)) and Example 14 (only using the first additive A2 of formula (4)), it can be determined that, compared with the lithium-ion battery made using the electrolyte containing only the first additive, the lithium-ion battery made using the electrolyte of the combination of the first additive and the second additive shows further improvements in terms of 5 C cycle retention rate at 60° C., 10 C cycle retention rate at 25° C., and cell volume growth rate, respectively.

In addition, by respectively comparing the results of Examples 1-4 (using the first additive A1 of formula (3) and the second additive B of formula (9), and the amount of A1 is in the range of 0.50-4.00 g) and Examples 5-6 (using the first additive A1 of formula (3) and the second additive B of formula (9), but the amount of A1 is 5.00 g or 0.10 g), as well as Examples 7-10 (using the first additive A2 of formula (4) and the second additive B of formula (9), and the amount of A2 is in the scope of 0.50-4.00 g) and Examples 11-12 (using the first additive A2 of formula (4) and the second additive B of formula (9), but the amount of A2 is 5.00 g or 0.10 g), it can be determined that when the amounts of the first additive and the second additive in 100 g of the basic electrolyte are in the range of 0.5 to 4 g and 0.5 to 2 g respectively, the corresponding lithium-ion batteries show even better performance in terms of 5 C cycle retention rate at 60° C. and 10 C cycle retention rate at 25° C. Especially when the amount of the first additive in 100 g of the basic electrolyte is in the range of 0.5 to 2 g (Examples 1-3 and 7-9), the corresponding lithium-ion batteries show particularly excellent performance in terms of 5 C cycle retention rate at 60° C. and 10 C cycle retention rate at 25° C.

The results of Example 5 and Example 11 show that when the content of the first additive in 100 g of the basic electrolyte is higher than 4 g, although the volume growth rate of the batteries is improved compared with Examples 1-4 and 7-10, the 5 C cycle retention rate at 60° C. and the 10 C cycle retention rate at 25° C. are significantly worse than those of Examples 1-4 and 7-10, and only the volume growth rate of the batteries is slightly better than that of the Comparative example.

The results of Example 6 and Example 12 show that when the content of the first additive and the second additive in 100 g of the basic electrolyte is lower than 0.5 g, compared with Examples 1-4 and Examples 7-10, respectively, the 5 C cycle retention rate at 60° C., the 10 C cycle retention rate at 25° C., and the volume growth rate of the batteries deteriorated, and only the 10 C cycle retention rate at 25° C. was slightly better than that of the Comparative example.

In summary, by adding the first additive and the optional second additive of the invention in the electrolyte of the lithium-ion battery, especially adding the first additive and the second additive of the invention in the specific amount limited by the invention, high-temperature cycle performance of lithium-ion batteries can be effectively improved.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An additive for a lithium-ion battery electrolyte, the additive comprising a first additive having a structure of formula (1): 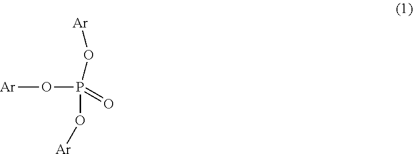
wherein each Ar is independently an aromatic group substituted with at least one substituent of a trifluoromethyl group, a trifluoromethyl alkyl group, a methoxy group, a trifluoromethoxy group, or a trifluoromethyl alkoxy group, wherein at least one of the at least one substituent is a trifluoromethyl group, a trifluoromethyl alkyl group, a trifluoromethoxy group, or a trifluoromethyl alkoxy group, and
optionally a second additive having a structure of the following formula (2), 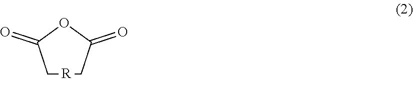
wherein R represents a divalent saturated or unsaturated hydrocarbon group.

2. The additive according to claim 1, wherein, the aromatic group is a phenyl group, a naphthyl group, or an anthracyl group.

3. The additive according to claim 1, wherein the first additive is any one selected from: 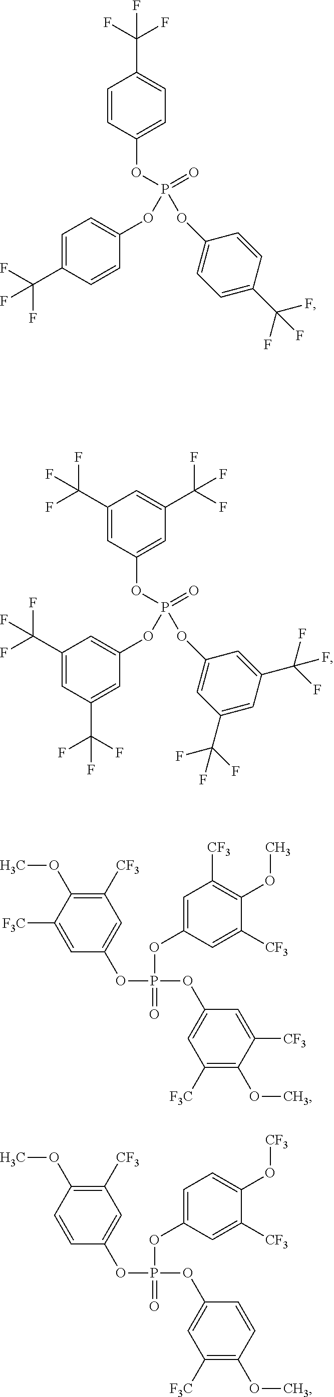 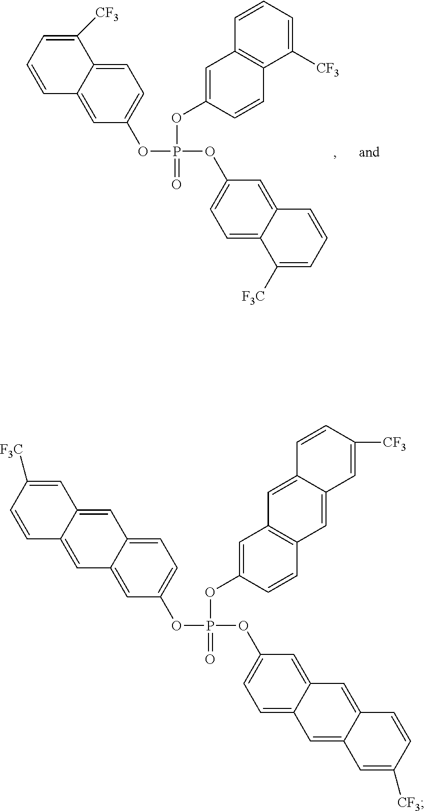 [SMILES: O=P(Oc1ccc2c(C(F)(F)F)cccc2c1)(Oc1ccc2c(C(F)(F)F)cccc2c1)Oc1ccc2c(C(F)(F)F)cccc2c1 ; O=P(Oc1ccc2cc3cc(C(F)(F)F)ccc3cc2c1)(Oc1ccc2cc3cc(C(F)(F)F)ccc3cc2c1)Oc1ccc2cc3cc(C(F)(F)F)ccc3cc2c1]
and optionally, the second additive is any one selected from:

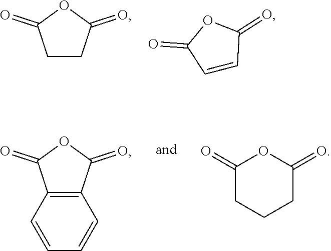

4. An electrolyte for a lithium-ion battery, comprising the additive of claim 1, an organic solvent, and a lithium salt.

5. The electrolyte according to claim 4, wherein the amount of the first additive is in the range of 0.5 parts by weight to 4 parts by weight, based on 100 parts by weight of the organic solvent and the lithium salt.

6. The electrolyte according to claim 5, wherein the amount of the first additive is in the range of 0.5 parts by weight to 2 parts by weight, based on 100 parts by weight of the organic solvent and the lithium salt.

7. The electrolyte according to claim 4, wherein the amount of the second additive is in the range of 0.5 parts by weight to 2 parts by weight, based on 100 parts by weight of the organic solvent and the lithium salt.

8. The electrolyte according to claim 4, wherein the organic solvent comprises a cyclic carbonate, a linear carbonate, or any combination thereof.

9. The electrolyte according to claim 4, wherein the lithium salt is selected from the group consisting of LiCl, LiBr, LiPF₆, LiBF₄, LiASF₆, LiClO₄, LiB(C₆H₅)₄, LiCH₃SO₃, LiCF₃SO₃, LiN(SO₂CF₃)₂, LiC(SO₂CF₃)₃, LiAlCl₄, Li₂SiF₆, or combinations thereof.

10. A lithium-ion secondary battery, comprising:
a positive electrode plate,
a negative electrode plate,
a separator, and
the electrolyte according to claim 4.
